(19) United States
(12) Patent Application Publication
(10) Pub. No.: US 2026/0087713 A1
(43) Pub. Date: Mar. 26, 2026

(54) GENERATIVE ANIMATABLE GAUSSIAN AVATAR

(71) Applicant: NVIDIA Corp., Santa Clara, CA (US)

(72) Inventors: Zhengming Yu, College Station, TX (US); Tianye Li, Cupertino, CA (US); Koki Nagano, Los Angeles, CA (US); Shalini De Mello, San Francisco, CA (US); Matthew Chan, Los Altos, CA (US)

(73) Assignee: NVIDIA Corp., Santa Clara, CA (US)

(21) Appl. No.: 19/340,679

(22) Filed: Sep. 25, 2025

Related U.S. Application Data
(60) Provisional application No. 63/699,059, filed on Sep. 25, 2024.
(60) Provisional application No. 63/748,692, filed on Jan. 23, 2025.

(51) Int. Cl. G06T 13/40; G06T 17/20

(52) U.S. Cl. CPC G06T 13/40; G06T 17/20

(57) ABSTRACT

Animation systems including an expressive deformation model configured to transform expression settings, pose settings, and a template mesh into an animatable mesh, a first generator branch configured to transform identity controls for the animatable mesh into base Gaussian attributes, a second generator branch configured to transform detail controls for the animatable mesh into residual Gaussian attributes, the system configured to embed the base Gaussian attributes and residual Gaussian attributes in UV maps of the animatable mesh and to combine the UV maps and the animatable mesh to form an animatable Gaussian representation of an object to animate.

### CROSS REFERENCE TO RELATED APPLICATIONS

This application claims priority and benefit of U.S. provisional patent application Ser. No. 63/699,059, filed on Sep. 25, 2024, the contents of which are incorporated herein by reference in their entirety. This application also claims priority and benefit of U.S. provisional patent application Ser. No. 63/748,692, filed on Jan. 23, 2025, the contents of which are incorporated herein by reference in their entirety.

### BACKGROUND

Systems to generate high-quality animatable avatars are useful for content creation (e.g., game production and film-making), telecommunication and teleconferencing (e.g., 3D video conferencing) as well as emerging technologies such as AR/VR/MR (augmented reality, virtual reality, and mixed reality, respectively), and synthetic agents.

Human faces comprise complex 3D (three-dimensional) volumes, including a high diversity of ages, genders and ethnicities (identity). Humans exhibit various expressions indicating emotional status of different levels (from subtle expressions to extreme ones). Human heads comprise multiple layers of details and appearances, including facial hair, teeth, eyeballs, inner mouth sockets, and multiple layers of skin appearances (often captured by multiple layers of texture maps in existing graphics pipelines). Furthermore, human viewers are sensitive to subtle changes and differences of another human in a realistic rendering (so-called “uncanny valley” effects).

A 3D animatable avatar is traditionally created by human artists, which costs time and money and requires a high level of artists skill. The creation process is complicated and includes multiple steps including 3D modeling, retopology, rigging, and texturing. To acquire high quality avatar assets, expensive high-end hardware may be required.

Some conventional mechanisms are able to reconstruct a head avatar given monocular inputs (videos), but these mechanisms rely on traditional (often mesh-based) graphics pipelines, lacking the capability to model realistic appearances in skin, teeth, hair or vivid facial expressions.

Recent volumetric representations such as neural radiance fields (NeRF) and Gaussian splatting enable the modeling complex geometry and appearances in an end-to-end manner. One such mechanism (INSTA) utilizes “instant-NGP” as the avatar representation. Other conventional mechanisms utilize 3D Gaussian splatting to obtain expressive animatable avatars with higher rendering efficiency than NeRF-based methods. This category of mechanisms generate a head avatar by reconstruction of input videos.

While achieving good quality, these mechanisms rely on data captured or curated at a higher quality, which requires additional processing and costs more time in run-time (test-time), as they need to fit their avatar representation to input data, often by iterative optimization techniques.

Another approach by conventional mechanisms utilizes generative models. The advantage of this approach is that high-quality generative models may be configured with single-view real (not synthesized) images during training. In these mechanisms, a trained decoder synthesizes high-quality images or 3D outputs efficiently by applying neural network inference. Conventional mechanisms utilizing this approach include EG3D, Next3D, WYSIWYG, and GGHead.

EG3D (FIG. 1) and WYSIWYG model a 3D head as a triplane representation. The learned latent space is able to encode a wide range of identities while maintaining high generation quality. However, the generated faces are static by design. With the interpolation in the learned latent space or driven by an additional encoder, the model presents some editing and animation capabilities. Meaningful control in the learned latent space is low or non-existent with these approaches.

Next3D (FIG. 3) utilizes a morphable face model, e.g., FLAME, and provides more meaningful animation controls than mechanisms such as EG3D. However, the animation quality may lack lack realism in details such as mouth corners. Next3D utilizes triplane-based neural radiance fields (NeRFs), which may be relatively slow for training and inference (rendering) than other approaches.

GGHead (FIG. 4) may achieve faster training and inference speeds than due to the higher efficiency of Gaussian splatting. In GGHead, the 3D representations (Gaussians) are built on top of a static template mesh instead of an animatable model, limiting animatability similar to EG3D.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 depicts a conventional EG3D avatar rendering mechanism.

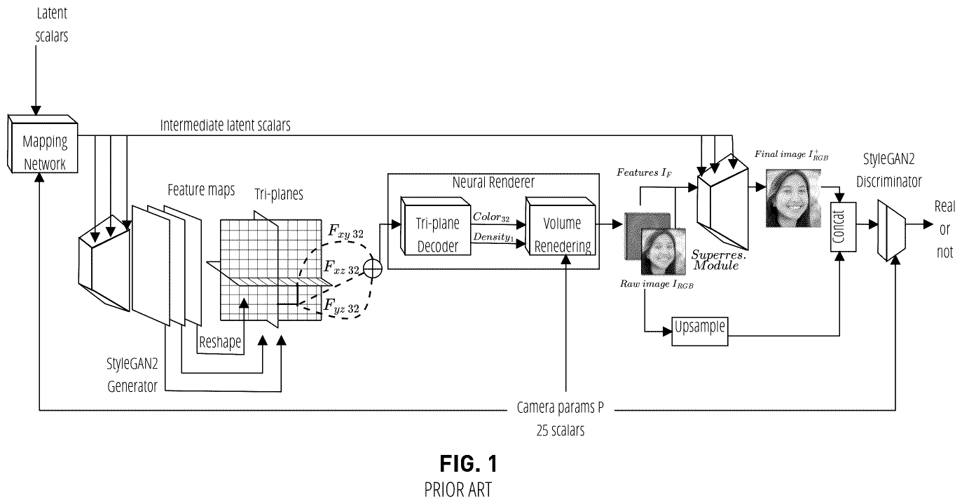

FIG. 2 depicts a conventional WYSIWYG avatar rendering mechanism.

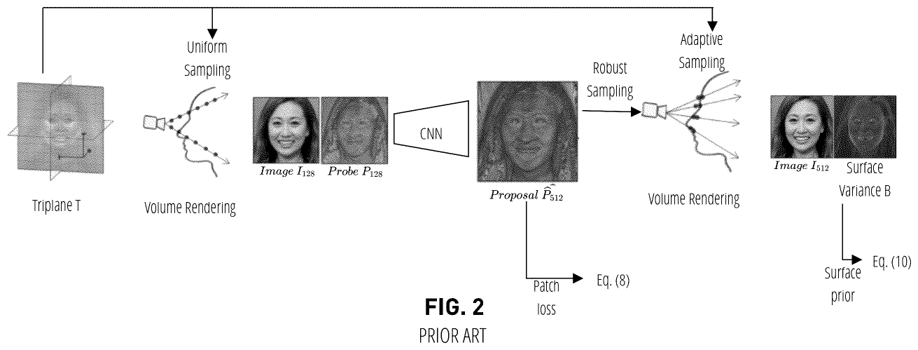

FIG. 3 depicts a conventional Next3D avatar rendering mechanism.

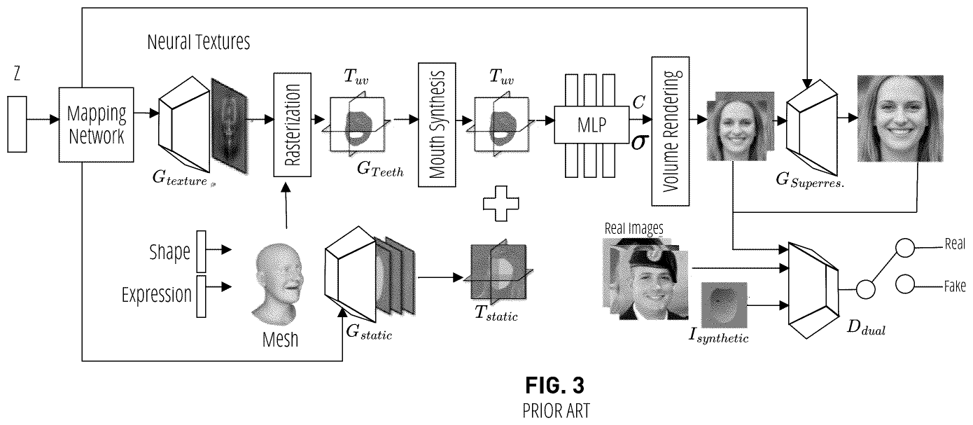

FIG. 4 depicts a conventional GGHead avatar rendering mechanism.

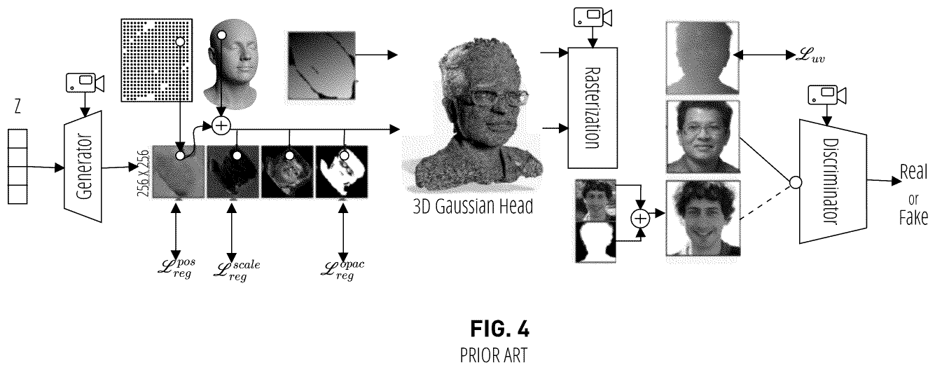

FIG. 5 is a high-level depiction of an embodiment of a system and process for generating expressive animatable avatars.

FIG. 6 depicts a training system and process for eye modeling and control in accordance with one embodiment.

FIG. 7 depicts additional aspects of a system and process for generating expressive animatable avatars in accordance with one embodiment.

FIG. 8 depicts an example of an expressive deformation model.

FIG. 9 depicts a training system and process for an expressive deformation model in accordance with one embodiment.

FIG. 10 depicts the generation of multi-layer Gaussian attributes in accordance with one embodiment.

FIG. 11 depicts a parallel processing unit 1102 in accordance with one embodiment.

FIG. 12 depicts a general processing cluster 1200 in accordance with one embodiment.

FIG. 13 depicts a memory partition unit 1300 in accordance with one embodiment.

FIG. 14 depicts a streaming multiprocessor 1400 in accordance with one embodiment.

FIG. 15 depicts a processing system 1500 in accordance with one embodiment.

FIG. 16 depicts an exemplary processing system 1600 in accordance with another embodiment.

### DETAILED DESCRIPTION

Disclosed herein are mechanisms to generate animatable human head avatars. The disclosed mechanisms generate Gaussians that model identity variations with a single latent variable (e.g., z) and that separate animation features from controls for identity, expression and pose.

“Identity” refers to variation in face/head shape excluding expression or pose. “Expression” refers to displays of emotion such as smiling, frowning, and so on. “Pose” refers to articulations of bones, joints, and eyes.

To support the independence of animation from the controls, the disclosed mechanisms utilize a base deformation model for animation, and a learnable (trainable) residual deformation model in a second generator branch to capture additional expressive details. The disclosed mechanisms may also apply disentanglement training.

The disclosed systems generate expressive, animatable Gaussian avatars, thereby providing realistic animation and efficient rendering. The inputs to the systems are latent vectors: z (identity), e (expression), p (poses, which includes jaw, neck and eyeballs motion), and an additional detail vector w. The systems utilize a deformation model to generate a mesh and further utilizes multiple generator models for base and detailed generation of the Gaussian attributes. The “base” attributes represent lower-frequency deformations depicting identity; the “detail” attributes represent higher-frequency and finer deformations of expression and appearance.

The mesh and Gaussian attributes together form a 3D representation for efficient (e.g., real-time AR/VR/MR) and high-fidelity avatar rendering. A human user, or driving animation logic, may animate a generated avatar by modulating or otherwise controlling the input latent vectors (e.g., via adjustment controls on a graphical user interface).

Given latent variables (identity, expression and pose), the disclosed mechanisms may synthesize a 3D human-realistic avatar that the system has not been trained on. The generated avatar comprises both shape and texture and supports animation (changing facial expressions, eye gazes, neck/jaw articulations, etc.) and enables realistic rendering from a wide range of viewpoints.

The disclosed mechanisms satisfy the following properties:
1. The system is generalizable: the model spans generation of avatars for a wide range of identities. The system may generate a novel subject, or generate a subject that resembles an existing subject by optimization/prediction techniques given input information (e.g., a portrait image).
2. The generated avatars are realistic in shape, appearance and animation.
3. The generation is sufficiently computationally efficient for real-time applications.

The disclosed mechanisms utilize Gaussian splats as a 3D representation of an animatable avatar. Conventional Gaussian splats comprise uncontrollable point clouds with various renderable attributes. To enable the animation capabilities, the disclosed mechanisms superimpose Gaussian attributes on an animatable mesh model. This also facilitates compatibility with existing graphics rendering tools. The disclosed mechanisms may utilize a base animation model that extends a conventional head morphable model such as FLAME with Gaussians.

FLAME (Faces Learned with an Articulated Model and Expressions) is a generative, articulated 3D head/face model useful for avatar creation and facial animation. FLAME is a parametric 3D face/head model trained from real 3D scan data. The model captures variation in identity (shape of the head/face), expression, pose (head, jaw, etc.), and appearance.

The disclosed mechanisms may embed Gaussian positions on the underlying animated mesh surface with barycentric weights and normal displacements. This enables the Gaussians to follow the dynamic mesh surface while the surface is deforming due to facial expression or pose changes, thus making the Gaussians animatable.

The disclosed mechanisms may embed other Gaussian attributes (rotation, scales, opacity and appearance) on a UV map of the animated mesh. The UV map of the mesh comprises a two-dimensional representation of a three-dimensional model's surface. It determines how textures are applied to the model by mapping positions in the texture (U and V coordinates) to corresponding points on the mesh. This mapping enables textures to be applied accurately in the intended locations on the model, ensuring an accurate visual appearance in 3D rendering.

The base formulation above models some low-frequency facial deformations via the embedded Gaussians, but may be inadequate to model all the expressive details of human heads. Detail (geometric) deformation is not fully captured by the FLAME model and the static embedding of the Gaussians. When a person is making expressions, not only the facial geometry is deforming, the appearance may change as well. Both the geometric and appearance details may be dynamic depending on the expression and pose of the subject at the moment.

To address these issues, the disclosed mechanisms utilize an additional deformation model to encode residual Gaussian attributes on top of the base representation. The complete expressive deformation mechanism thus models the base animated mesh by a morphable head model, plus a second deformation generator model trained to encode the residuals. This residual generator may learn via training the additional deformations of the driving mesh that capture more expressive details.

The additional set of residual Gaussian attributes may encode position, rotation, scale, opacity, and appearance. These residual Gaussian attributes may capture dynamic geometric deformation as well as dynamic appearances. The generative network portion of the system may be trained to output these expressive representations while maintaining animation capabilities.

The disclosed mechanisms utilize a first generative model that inputs a latent code z (encoding the identity of the generated subject) and that outputs base Gaussian attributes that align with the UV map of the generated head. For the residual details, a second generative model is utilized that inputs a latent code w, expression code e, and pose parameters p, such that the output of the second generator depends on expression and pose changes.

The second generator may optionally input the identity code z to capture identity-dependent dynamic details. In some embodiments, the detail vector w is further separated into identity details w_id, expression details w_e, and pose details w_p.

The second generator outputs a set of residual Gaussian attributes maps. The residual maps may be applied on top of the base maps to configure the final expressive Gaussian attributes. Combined with the underlying driving mesh output from the expressive deformation model, the full set of dynamic Gaussians and the animatable Gaussian avatar are obtained. With discriminator and Generative Adversarial Network (GAN) training, the generators and the residual deformation model may be configured to work together to generate realistic avatars.

The mechanisms described above treat the identity branch and the expressive branch as separate branches. The expressive details are relatively local in the avatar model. In some embodiments the expressive residual generation may be enhanced by injecting additional intermediate features from an additional encoder (not depicted). One choice such an encoder is a pre-trained vision transformer such as DiNO.

The pose parameter p may comprise jaw articulations, neck articulations, and eyeball rotations. The base animated mesh provided by the expressive deformation model is configured to model these articulations. However, conventional expressive deformation models only provide meshes (geometry) but do not provide appearances (especially dynamic appearances). In particular, eyeballs and inner mouths are highly complex features comprising challenging view-dependent appearance (specularity, multiple layers in eyeballs) and occlusion (teeth, tongue and inner mouth socket). In addition to the multi-layer representation mentioned above, the disclosed mechanisms additionally sample Gaussians within the eyeballs and inner mouth sockets (instead of near the driving mesh surface) to capture those challenging geometry and appearances.

To enable expressive animation capabilities, each input is assigned a meaningful and independent interpretation. The disclosed mechanisms may utilize a multi-stage training (model configuration) scheme whereby additional conditional variables and disentanglement training strategies are applied. The subject's shape and appearance should be maintained to be substantially consistent during animation. The disclosed mechanisms may apply regularization losses and local discriminators to encourage highly expressive and consistent outputs.

The disclosed mechanisms may apply a coarse-to-fine training schedule to certain models utilized in the system. This configures the system to learn realistic variations. For the generators, the disclosed mechanisms may first train the base branch (identity) only in a first phase, and then train both the base branch and the expressive residual branch together in a second phase. To generate the underlying driving mesh during training, the disclosed mechanisms may first utilize the base deformation model (e.g., FLAME) only, and then utilize both of the base model and the trainable residual model.

If multiple inputs (e.g., video frames) of the same person are provided during training, the disclosed mechanisms may optionally train the residual Gaussian attributes branch with additional input of the identity variable, to learn the person-specific dynamic details (expressions).

In one embodiment, a camera pose is applied as an additional conditioning variable to the system discriminator. The disclosed mechanisms may condition the discriminator on additional variables as well to configure the discriminator to discern expressive details, and thus urge (during training) the generator to capture and model those expressive details. As noted previously, the expressive variables may include expression e, pose p, and optionally identity z, where the pose parameter p may comprise jaw, neck and eyeballs parameters.

In particular, to achieve expressive animation in the eye area, the disclosed mechanisms may apply gaze information (as part of the pose p) for training. Local discriminators of the system may be configured to focus on the eye region to further improve the realism of eye motion.

A risk of training both the identity and expression (and pose) is that the two are mixed during training. The disclosed mechanisms may apply additional training strategies to encourage disentanglement of identity and expression. These may include:
4. Cycle consistency: The disclosed mechanisms may implement identity and emotion recognition networks to encourage the generated avatar's rendering to comprise the same identity and emotion as the input identity and emotion. This additional loss function term essentially forms a cycle consistency from the input to the output.
5. Cycle consistency with on-the-fly perturbation: For example, a half-trained generator may be operated to generate new expressions (perturbed, permuted, and neutral) to adapt the system to generation of more diverse expressions.
6. Contrastive loss: The disclosed mechanisms may apply contrastive loss to regularize the distribution of the latent codes of expression and poses.

“Floating artifacts” may be produced due to the unrealistic movement of Gaussians while the control latent variable(s) interpolate. To encourage the Gaussians to move in a reasonable manner (e.g., for realistic skin deformation) while the mesh surface is retained in a realistic correspondence, the disclosed mechanisms may add a total-variation (TV) regularization term to encourage the smoothness of positional attributes on the UV map.

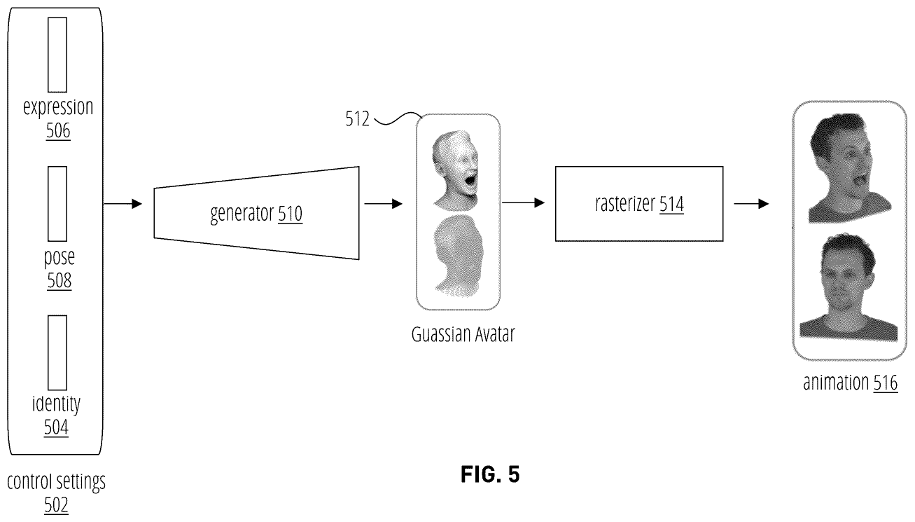

FIG. 5 is a high-level depiction of an embodiment of a system and process for generating expressive animatable avatars. The system may be utilized to generate realistic human head avatars. The system utilize volumetric representations (NeRF, Gaussian, etc) and combines generative models and expressive animation mechanisms. The system may utilize an expressive deformation model 702 and residual Gaussian attributes 704 to capture additional rendering details and may apply disentanglement training. Active data mining techniques may be utilized to obtain expressive training datasets for the system.

The system transforms latent control settings 502 (identity 504, expression 506, and pose 508) into a depiction of a human, face, and expression (a 3D human avatar). The generated avatar comprises both shape and texture and supports animation (changing facial expressions, eye gazes, neck/jaw articulations, etc.) as well as realistic rendering from a wide range of viewpoints.

The generator 510 model efficiently transforms control settings 502 (i.e., latent vectors) into an animatable Gaussian avatar 512. The Gaussian avatar 512 may then be processed through a rasterizer 514 to generate an animation 516.

In one embodiment, the latent vectors comprising the control settings 502 originate from an image or video encoder.

The system is generalizable to incorporate for a wide range of human characteristics. The system may generate an avatar “from scratch” without input guidance (e.g., by sampling input noise for the latent vector), or may generate an avatar that resembles input guidance (e.g., an image or video of the human subject). The generated avatars may be realistic in shape, appearance and animation and may be generated with sufficient performance and efficiency to satisfy the constraints of real-time/on demand applications.

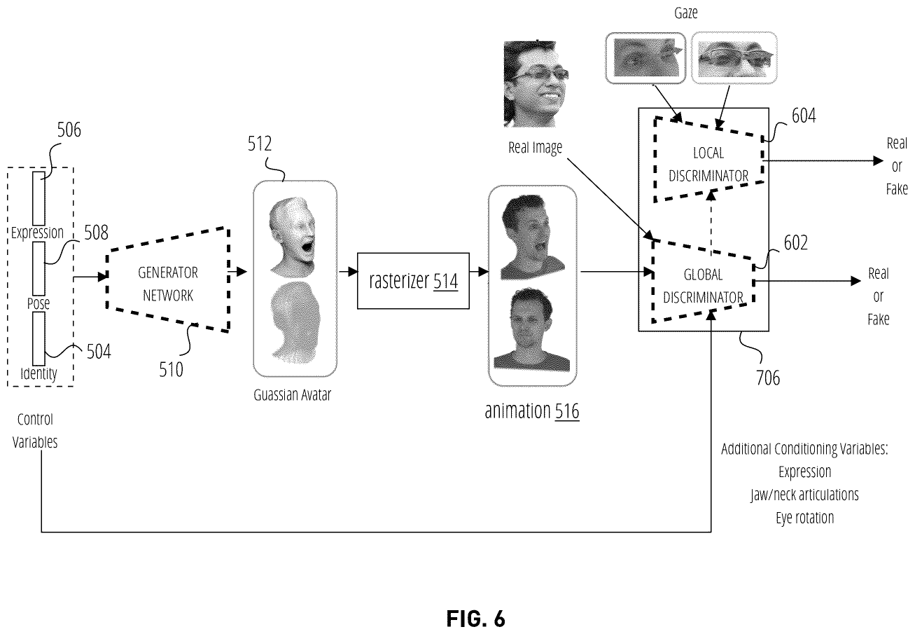

FIG. 6 depicts a GAN training system and process for eye modeling and control in accordance with one embodiment. GAN training refers to the process of training Generative Adversarial Networks, a class of machine learning models. GAN training typically involves two neural networks, a generator 510 network and a discriminator 706 network, which compete against each other in a zero-sum game.

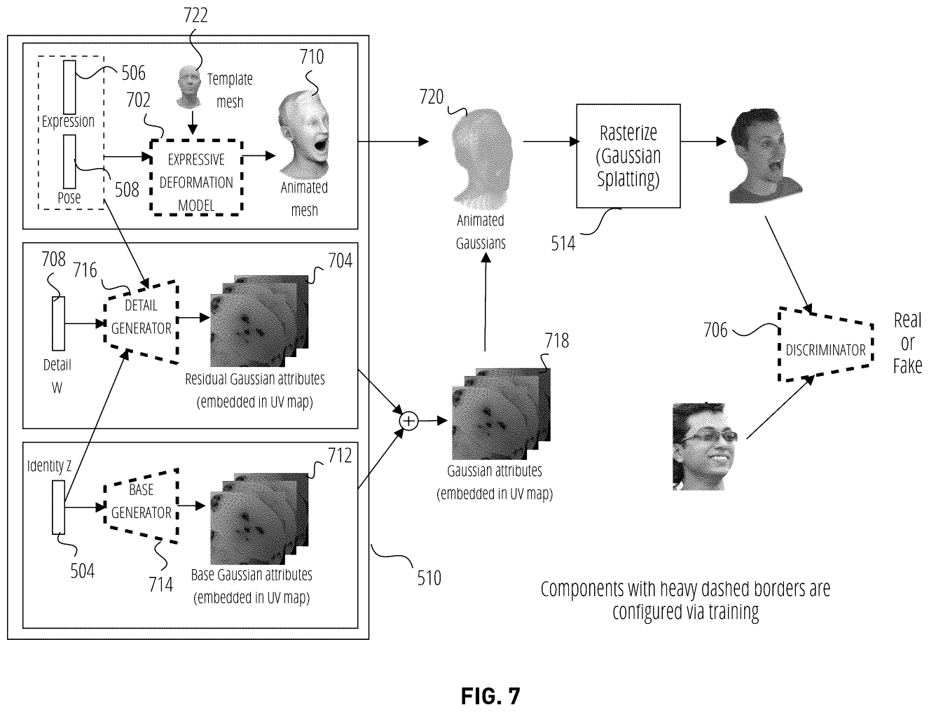

In the GAN depicted in FIG. 6 and FIG. 7, the generator 510 outputs new data instances that mimic real data. It learns to create data that is close to a realistic data distribution. The discriminator 706 portion of the GAN evaluates the authenticity of the data provided by the generator portion against real-world data, distinguishing between the two. Its task is to correctly identify which data is real and which is generated. The discriminator 706 may comprise a global discriminator 602 to discriminate between overall features of the the real and synthetic data, and a local discriminator 604 to discriminate between local features such as gaze.

With sufficient training, the generator 510 may produce highly realistic synthetic data that the discriminator 706 can no longer distinguish from the real data.

FIG. 7 depicts additional aspects of a system and process for generating expressive animatable avatars in accordance with one embodiment.

The system inputs latent vectors: z (identity 504), e (expression 506), p (poses 508, which includes jaw, neck and eyeballs motion) as well as an additional detail 708 vector w. The system utilizes an expressive deformation model 702 to generate an animated mesh 710. The system transforms these inputs into base Gaussian attributes 712 and residual Gaussian attributes 704 utilizing a generator model 714 and a generator model 716, respectively. The base Gaussian attributes 712 and residual Gaussian attributes 704 are combined into total Gaussian attributes 718.

The combination of the animated mesh 710 and total Gaussian attributes 718 together form a 3D representation comprising animated Gaussians 720 that enables efficient (real-time) and high-fidelity rendering. A human operator or an artificial intelligence model or algorithm may animate the generated avatar by controlling the input latent vectors z, e, p, and w. A rasterizer 514 may apply Gaussian splats to the animated Gaussians 720 to render realistic facial details.

The animated mesh 710 may be based upon a template mesh 722. The template mesh 722 may be applied to an existing head morphable model such as FLAME that inputs expression and pose parameters and outputs a deformed and expressed mesh.

Gaussian positions may be embedded on the underlying animated mesh 710 surface with barycentric weights and normal displacements. This enables the Gaussians to follow the dynamic mesh surface while the surface is deforming due to facial expression or pose changes, thus making the Gaussians animatable. Other Gaussian attributes (rotation, scales, opacity and appearance) may be embedded on a UV map of the animated mesh. A UV map of a mesh model is a 2D representation of a 3D model's surface. It involves unwrapping the 3D geometry to create a flat layout, where “U” and “V” are the axes of the 2D texture coordinates. This map enables textures to be accurately applied to the 3D model, helping ensure that the imagery, patterns, or colors align correctly with the model's surface.

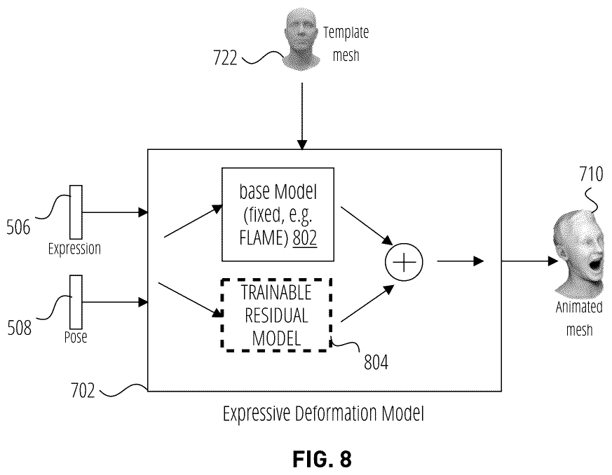

FIG. 8 depicts an example of an expressive deformation model 702 utilizing dynamic residuals for expressive details.

The base modeling described in conjunction with FIG. 7 effectively models low-frequency facial deformations via the embedded Gaussians, but may inadequately model more expressive and high-frequency details of human heads and faces. Detailed and high frequency deformations may not be fully captured by the base model 802 and the static embedding of the Gaussians. When a person is making expressions the facial geometry deforms and the appearance may change as well. Geometric and appearance details are dynamic depending on the expression and pose of the subject at the moment.

The system may utilize an additional deformation model to encode the residual Gaussian attributes. The base animated mesh 710 may be modeled with a morphable head model (the base model 802) and additionally with a trainable residual model 804. The trainable residual model 804 may learn additional deformation of the driving template mesh 722 that captures more expressive details. The additional set of residual Gaussian attributes 704 for position may be generated, such as rotation, scales, opacity and appearance. These residual Gaussian attributes 704 may capture dynamic geometric deformation as well as dynamic appearances.

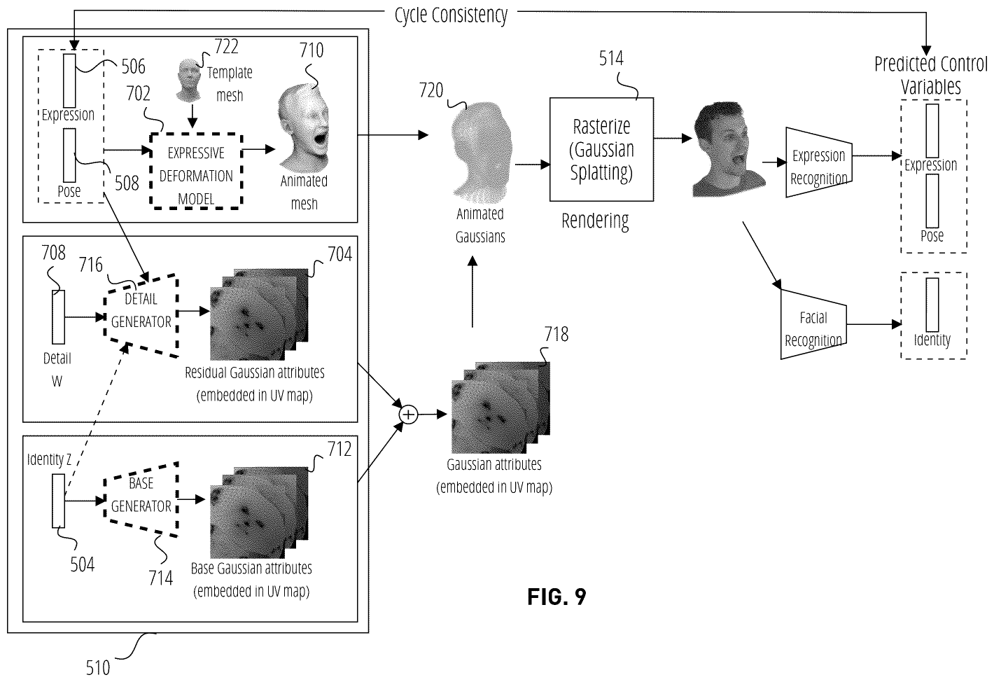

FIG. 9 depicts a training system and process for an expressive deformation model 702 in accordance with one embodiment. The system comprises a generator model 714 (e.g., StyleGAN) that inputs a latent code z (which encodes the identity 504 of the generated subject) and outputs base Gaussian attributes 712 that align with a UV map of the generated head rendering.

StyleGAN (Style-based Generator Architecture for Generative Adversarial Networks) is a family of generative models from NVIDIA® Research (introduced in 2018, with later versions StyleGAN2, StyleGAN3). StyleGAN is a type of Generative Adversarial Network (GAN) specialized for creating high-quality, photorealistic images. StyleGAN is applicable for generating realistic synthetic human faces.

For capturing residual details, another generator model 716 (e.g., StyleGAN) is utilized that inputs the detail 708 code w as well as the expression 506 code e and pose 508 parameters p such that the output of the second generator model 714 reflects expression and pose changes and thus captures dynamic details. The generator model 714 may optionally input the identity 504 code z to capture identity-dependent dynamic details.

The detail vector w may be segregated into three categories: identity details w_id, expression details w_e, and pose details w_p. The generator model 716 may output a set of residual Gaussian attribute maps (704). The residual maps 704 may be applied on top of the base Gaussian attribute maps 712 to form a combined set of expressive Gaussian attributes 718. Combined with animated mesh 710 output from the expressive deformation model 702, a full set of dynamic Gaussians are obtained, thereby forming an animatable Gaussian avatar 512. With discriminator and GAN training, the generators 714, 716 and the residual de formation model 804 may be configured to work together to generate realistic avatars. In one embodiment, camera pose variables (not depicted) may be provided as an additional conditioning variable to the discriminator 706.

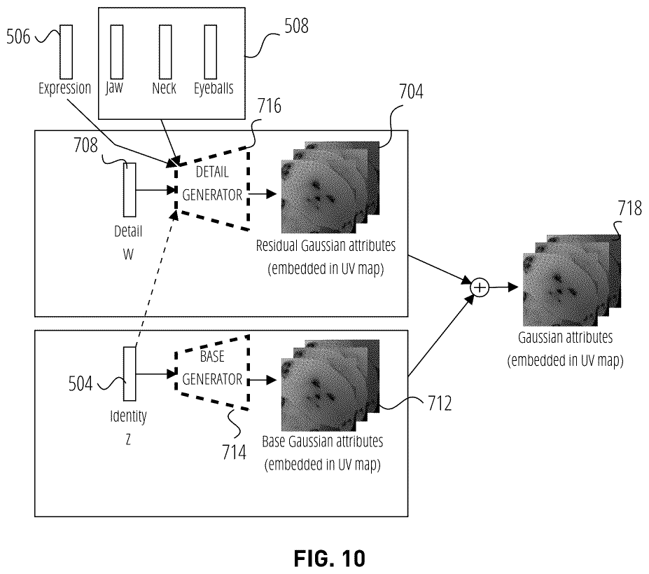

Conditioning on additional variables may also be applied to encourage the discriminator 706 to focus on expressive details and thus encourage the generator 510 to capture and model the expressive details. The variables that may be focused during GAN training include expression e, pose p, and optionally identity z. The pose parameter p may comprise attributes for jaw, neck, and eyeballs (FIG. 10). To enable expressive animation in the eye area, gaze attributes (as part of the pose p) may be applied during training. One or more local discriminator 604 may be utilized to focus on the eye region of the 3D model to further improve the realism of the eye motion.

Because expressive details are relatively localized in the model, in one embodiment the residual generator model 716 may be modified by injecting additional intermediate features from an additional encoder. A choice for such an encoder is a pre-trained vision transformer such as DiNO.

The mechanisms disclosed herein may be implemented (e.g., as non-volatile machine-readable memory-resident instructions, e.g., in main memory 1602) to configure computing devices utilizing one or more graphic processing unit (GPU, e.g., parallel processing module 1502) and/or general purpose data processor (e.g., a ‘central processing unit’ or CPU, e.g., central processing unit 1504). Exemplary machine architectures will now be described that may be configured to carry out the mechanisms disclosed herein on such devices.

The following description may use certain acronyms and abbreviations as follows:
“DPC” refers to a “data processing cluster”;
“GPC” refers to a “general processing cluster”;
“I/O” refers to a “input/output”;
“L1 cache” refers to “level one cache”;
“L2 cache” refers to “level two cache”;
“LSU” refers to a “load/store unit”;
“MMU” refers to a “memory management unit”;
“MPC” refers to an “M-pipe controller”;
“PPU” refers to a “parallel processing unit”;
“PROP” refers to a “pre-raster operations unit”;
“ROP” refers to a “raster operations”;
“SFU” refers to a “special function unit”;
“SM” refers to a “streaming multiprocessor”;
“Viewport SCC” refers to “viewport scale, cull, and clip”;
“WDX” refers to a “work distribution crossbar”; and
“XBar” refers to a “crossbar”.

### Parallel Processing Unit

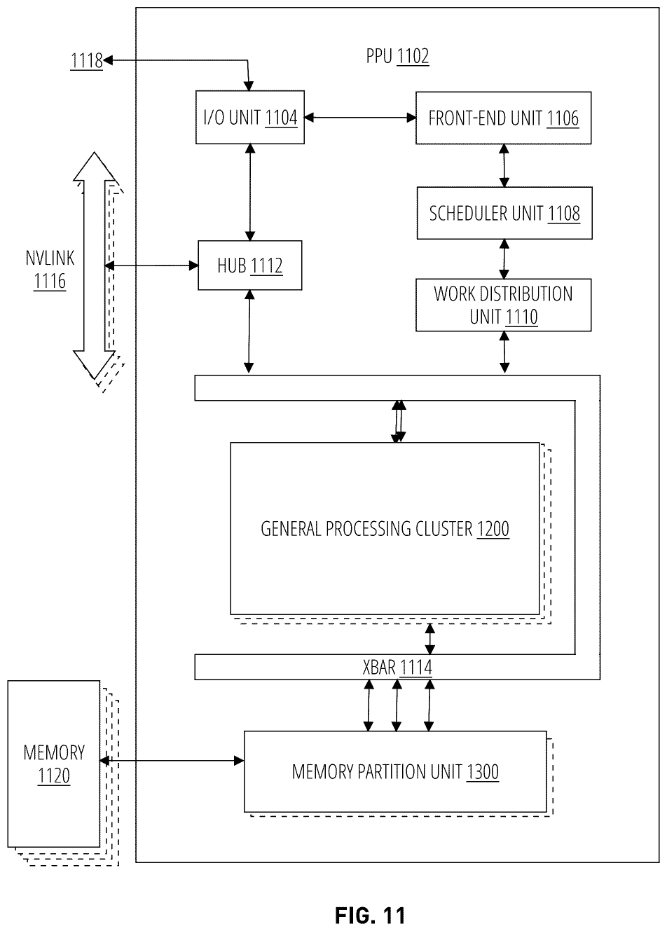

FIG. 11 depicts a parallel processing unit 1102, in accordance with an embodiment. In an embodiment, the parallel processing unit 1102 is a multi-threaded processor that is implemented on one or more integrated circuit devices. The parallel processing unit 1102 is a latency hiding architecture designed to process many threads in parallel. A thread (e.g., a thread of execution) is an instantiation of a set of instructions configured to be executed by the parallel processing unit 1102. In an embodiment, the parallel processing unit 1102 is a graphics processing unit (GPU) configured to implement a graphics rendering pipeline for processing three-dimensional (3D) graphics data in order to generate two-dimensional (2D) image data for display on a display device such as a liquid crystal display (LCD) device. In other embodiments, the parallel processing unit 1102 may be utilized for performing general-purpose computations. While one exemplary parallel processor is provided herein for illustrative purposes, it should be strongly noted that such processor is set forth for illustrative purposes only, and that any processor may be employed to supplement and/or substitute for the same.

One or more parallel processing unit 1102 modules may be configured to accelerate thousands of High Performance Computing (HPC), data center, and machine learning applications. The parallel processing unit 1102 may be configured to accelerate numerous deep learning systems and applications including autonomous vehicle platforms, deep learning, high-accuracy speech, image, and text recognition systems, intelligent video analytics, molecular simulations, drug discovery, disease diagnosis, weather forecasting, big data analytics, astronomy, molecular dynamics simulation, financial modeling, robotics, factory automation, real-time language translation, online search optimizations, and personalized user recommendations, and the like.

As shown in FIG. 11, the parallel processing unit 1102 includes an I/O unit 1104, a front-end unit 1106, a scheduler unit 1108, a work distribution unit 1110, a hub 1112, a crossbar 1114, one or more general processing cluster 1200 modules, and one or more memory partition unit 1300 modules. The parallel processing unit 1102 may be connected to a host processor or other parallel processing unit 1102 modules via one or more high-speed NVLink 1116 interconnects. The parallel processing unit 1102 may be connected to a host processor or other peripheral devices via an interconnect 1118. The parallel processing unit 1102 may also be connected to a local memory comprising a number of memory 1120 devices. In an embodiment, the local memory may comprise a number of dynamic random access memory (DRAM) devices. The DRAM devices may be configured as a high-bandwidth memory (HBM) subsystem, with multiple DRAM dies stacked within each device. The memory 1120 may comprise logic to configure the parallel processing unit 1102 to carry out aspects of the techniques disclosed herein.

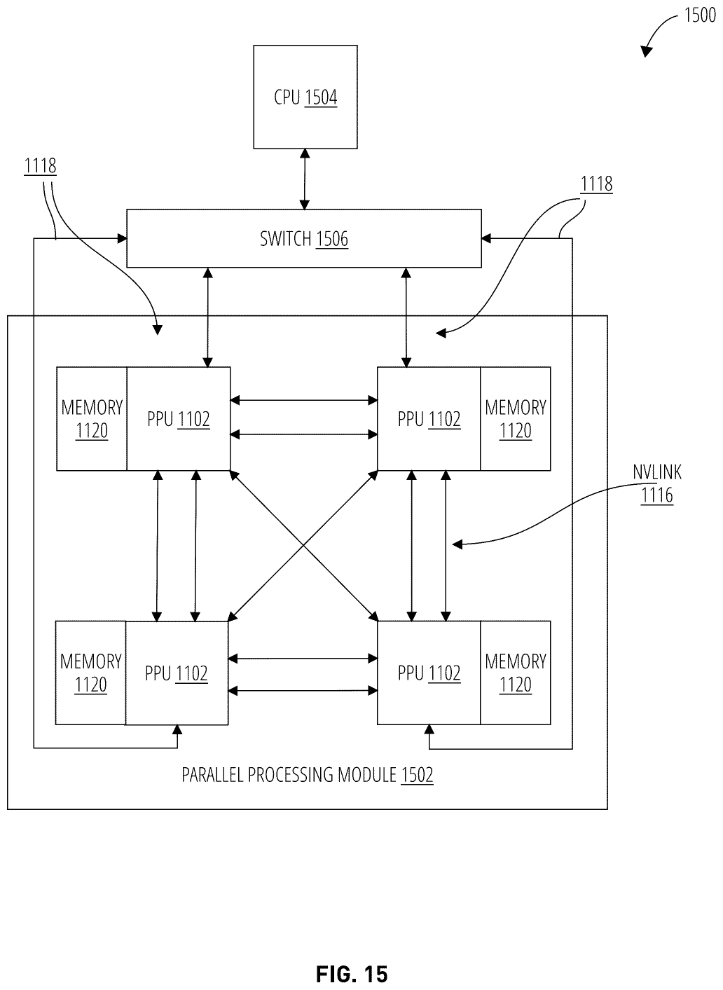

The NVLink 1116 interconnect enables systems to scale and include one or more parallel processing unit 1102 modules combined with one or more CPUs, supports cache coherence between the parallel processing unit 1102 modules and CPUs, and CPU mastering. Data and/or commands may be transmitted by the NVLink 1116 through the hub 1112 to/from other units of the parallel processing unit 1102 such as one or more copy engines, a video encoder, a video decoder, a power management unit, etc. (not explicitly shown). The NVLink 1116 is described in more detail in conjunction with FIG. 15.

The I/O unit 1104 is configured to transmit and receive communications (e.g., commands, data, etc.) from a host processor (not shown) over the interconnect 1118. The I/O unit 1104 may communicate with the host processor directly via the interconnect 1118 or through one or more intermediate devices such as a memory bridge. In an embodiment, the I/O unit 1104 may communicate with one or more other processors, such as one or more parallel processing unit 1102 modules via the interconnect 1118. In an embodiment, the I/O unit 1104 implements a Peripheral Component Interconnect Express (PCIe) interface for communications over a PCIe bus and the interconnect 1118 is a PCIe bus. In alternative embodiments, the I/O unit 1104 may implement other types of well-known interfaces for communicating with external devices.

The I/O unit 1104 decodes packets received via the interconnect 1118. In an embodiment, the packets represent commands configured to cause the parallel processing unit 1102 to perform various operations. The I/O unit 1104 transmits the decoded commands to various other units of the parallel processing unit 1102 as the commands may specify. For example, some commands may be transmitted to the front-end unit 1106. Other commands may be transmitted to the hub 1112 or other units of the parallel processing unit 1102 such as one or more copy engines, a video encoder, a video decoder, a power management unit, etc. (not explicitly shown). In other words, the I/O unit 1104 is configured to route communications between and among the various logical units of the parallel processing unit 1102.

In an embodiment, a program executed by the host processor encodes a command stream in a buffer that provides workloads to the parallel processing unit 1102 for processing. A workload may comprise several instructions and data to be processed by those instructions. The buffer is a region in a memory that is accessible (e.g., read/write) by both the host processor and the parallel processing unit 1102. For example, the I/O unit 1104 may be configured to access the buffer in a system memory connected to the interconnect 1118 via memory requests transmitted over the interconnect 1118. In an embodiment, the host processor writes the command stream to the buffer and then transmits a pointer to the start of the command stream to the parallel processing unit 1102. The front-end unit 1106 receives pointers to one or more command streams. The front-end unit 1106 manages the one or more streams, reading commands from the streams and forwarding commands to the various units of the parallel processing unit 1102.

The front-end unit 1106 is coupled to a scheduler unit 1108 that configures the various general processing cluster 1200 modules to process tasks defined by the one or more streams. The scheduler unit 1108 is configured to track state information related to the various tasks managed by the scheduler unit 1108. The state may indicate which general processing cluster 1200 a task is assigned to, whether the task is active or inactive, a priority level associated with the task, and so forth. The scheduler unit 1108 manages the execution of a plurality of tasks on the one or more general processing cluster 1200 modules.

The scheduler unit 1108 is coupled to a work distribution unit 1110 that is configured to dispatch tasks for execution on the general processing cluster 1200 modules. The work distribution unit 1110 may track a number of scheduled tasks received from the scheduler unit 1108. In an embodiment, the work distribution unit 1110 manages a pending task pool and an active task pool for each of the general processing cluster 1200 modules. The pending task pool may comprise a number of slots (e.g., 32 slots) that contain tasks assigned to be processed by a particular general processing cluster 1200. The active task pool may comprise a number of slots (e.g., 4 slots) for tasks that are actively being processed by the general processing cluster 1200 modules. As a general processing cluster 1200 finishes the execution of a task, that task is evicted from the active task pool for the general processing cluster 1200 and one of the other tasks from the pending task pool is selected and scheduled for execution on the general processing cluster 1200. If an active task has been idle on the general processing cluster 1200, such as while waiting for a data dependency to be resolved, then the active task may be evicted from the general processing cluster 1200 and returned to the pending task pool while another task in the pending task pool is selected and scheduled for execution on the general processing cluster 1200.

The work distribution unit 1110 communicates with the one or more general processing cluster 1200 modules via crossbar 1114. The crossbar 1114 is an interconnect network that couples many of the units of the parallel processing unit 1102 to other units of the parallel processing unit 1102. For example, the crossbar 1114 may be configured to couple the work distribution unit 1110 to a particular general processing cluster 1200. Although not shown explicitly, one or more other units of the parallel processing unit 1102 may also be connected to the crossbar 1114 via the hub 1112.

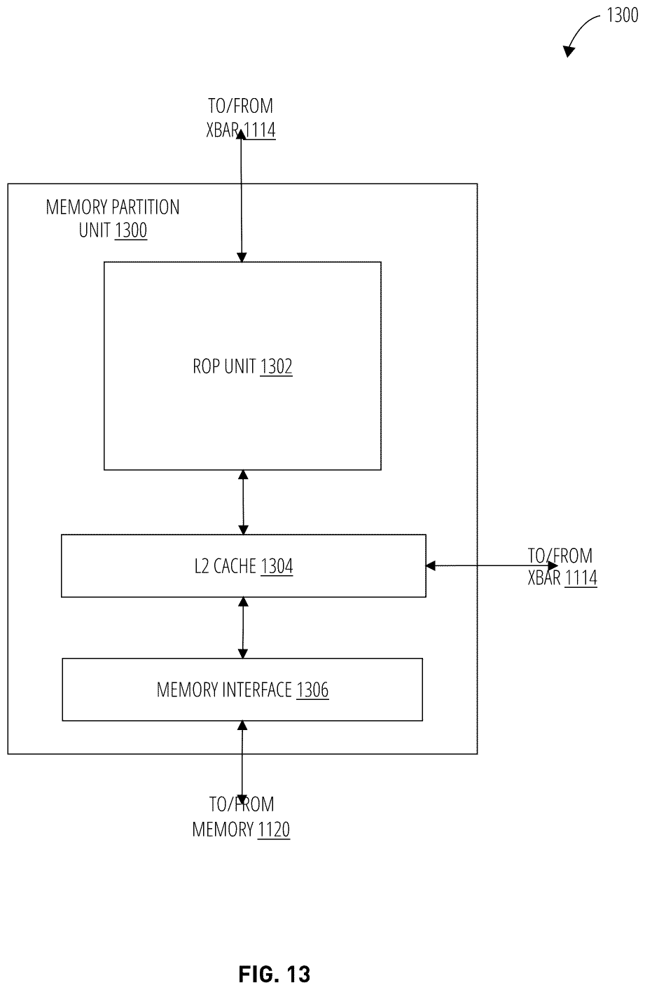

The tasks are managed by the scheduler unit 1108 and dispatched to a general processing cluster 1200 by the work distribution unit 1110. The general processing cluster 1200 is configured to process the task and generate results. The results may be consumed by other tasks within the general processing cluster 1200, routed to a different general processing cluster 1200 via the crossbar 1114, or stored in the memory 1120. The results can be written to the memory 1120 via the memory partition unit 1300 modules, which implement a memory interface for reading and writing data to/from the memory 1120. The results can be transmitted to another parallel processing unit 1102 or CPU via the NVLink 1116. In an embodiment, the parallel processing unit 1102 includes a number U of memory partition unit 1300 modules that is equal to the number of separate and distinct memory 1120 devices coupled to the parallel processing unit 1102. A memory partition unit 1300 will be described in more detail below in conjunction with FIG. 13.

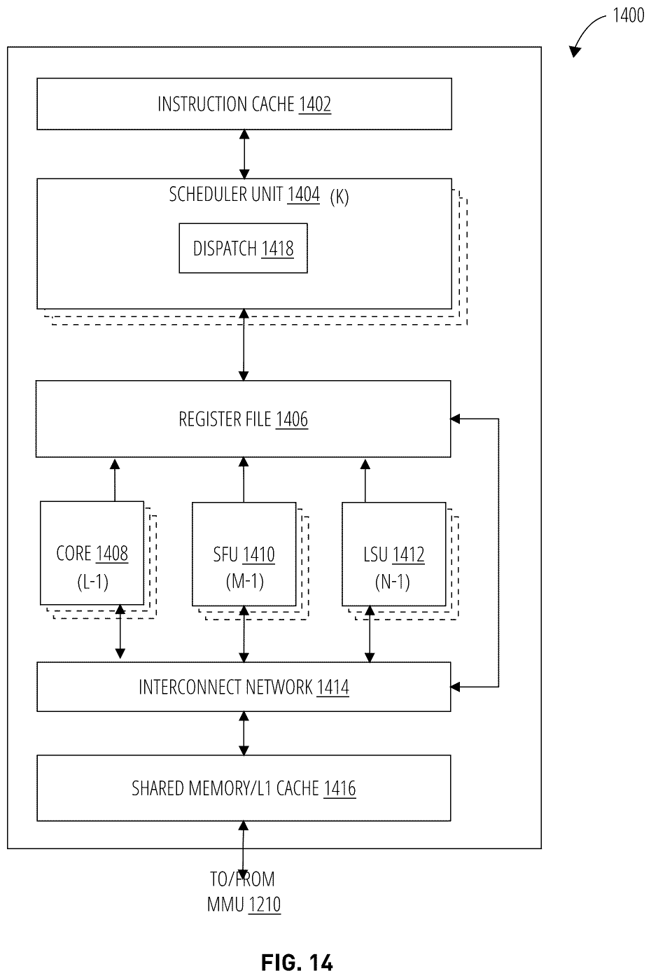

In an embodiment, a host processor executes a driver kernel that implements an application programming interface (API) that enables one or more applications executing on the host processor to schedule operations for execution on the parallel processing unit 1102. In an embodiment, multiple compute applications are simultaneously executed by the parallel processing unit 1102 and the parallel processing unit 1102 provides isolation, quality of service (QoS), and independent address spaces for the multiple compute applications. An application may generate instructions (e.g., API calls) that cause the driver kernel to generate one or more tasks for execution by the parallel processing unit 1102. The driver kernel outputs tasks to one or more streams being processed by the parallel processing unit 1102. Each task may comprise one or more groups of related threads, referred to herein as a warp. In an embodiment, a warp comprises 32 related threads that may be executed in parallel. Cooperating threads may refer to a plurality of threads including instructions to perform the task and that may exchange data through shared memory. Threads and cooperating threads are described in more detail in conjunction with FIG. 14.

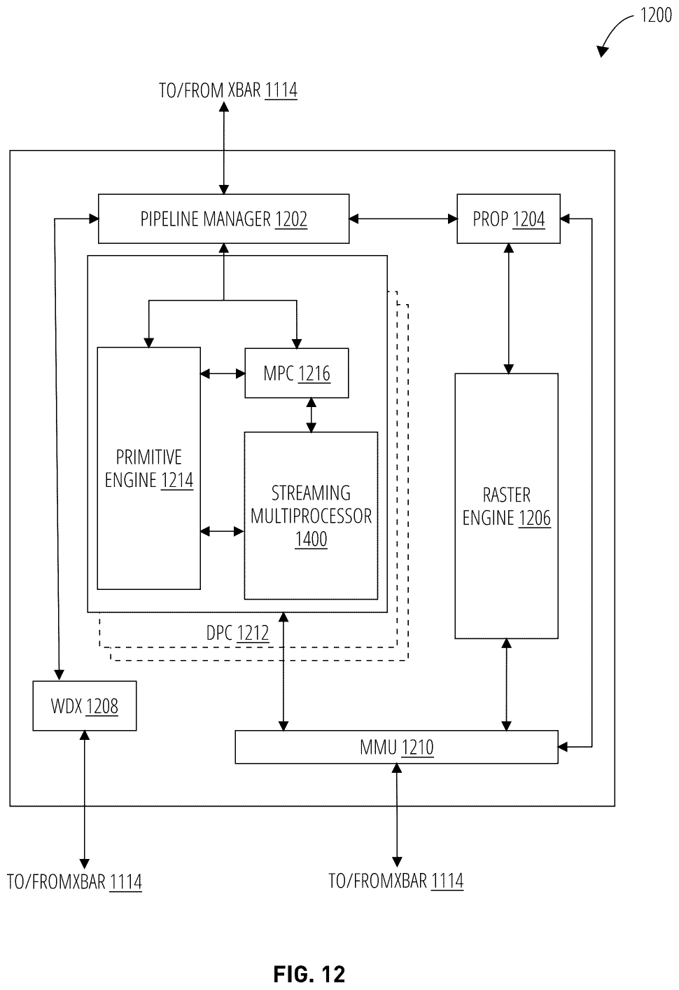

FIG. 12 depicts a general processing cluster 1200 of the parallel processing unit 1102 of FIG. 11, in accordance with an embodiment. As shown in FIG. 12, each general processing cluster 1200 includes a number of hardware units for processing tasks. In an embodiment, each general processing cluster 1200 includes a pipeline manager 1202, a pre-raster operations unit 1204, a raster engine 1206, a work distribution crossbar 1208, a memory management unit 1210, and one or more data processing cluster 1212. It will be appreciated that the general processing cluster 1200 of FIG. 12 may include other hardware units in lieu of or in addition to the units shown in FIG. 12.

In an embodiment, the operation of the general processing cluster 1200 is controlled by the pipeline manager 1202. The pipeline manager 1202 manages the configuration of the one or more data processing cluster 1212 modules for processing tasks allocated to the general processing cluster 1200. In an embodiment, the pipeline manager 1202 may configure at least one of the one or more data processing cluster 1212 modules to implement at least a portion of a graphics rendering pipeline. For example, a data processing cluster 1212 may be configured to execute a vertex shader program on the programmable streaming multiprocessor 1400. The pipeline manager 1202 may also be configured to route packets received from the work distribution unit 1110 to the appropriate logical units within the general processing cluster 1200. For example, some packets may be routed to fixed function hardware units in the pre-raster operations unit 1204 and/or raster engine 1206 while other packets may be routed to the data processing cluster 1212 modules for processing by the primitive engine 1214 or the streaming multiprocessor 1400. In an embodiment, the pipeline manager 1202 may configure at least one of the one or more data processing cluster 1212 modules to implement a neural network model and/or a computing pipeline.

The pre-raster operations unit 1204 is configured to route data generated by the raster engine 1206 and the data processing cluster 1212 modules to a Raster Operations (ROP) unit, described in more detail in conjunction with FIG. 13. The pre-raster operations unit 1204 may also be configured to perform optimizations for color blending, organize pixel data, perform address translations, and the like.

The raster engine 1206 includes a number of fixed function hardware units configured to perform various raster operations. In an embodiment, the raster engine 1206 includes a setup engine, a coarse raster engine, a culling engine, a clipping engine, a fine raster engine, and a tile coalescing engine. The setup engine receives transformed vertices and generates plane equations associated with the geometric primitive defined by the vertices. The plane equations are transmitted to the coarse raster engine to generate coverage information (e.g., an x, y coverage mask for a tile) for the primitive. The output of the coarse raster engine is transmitted to the culling engine where fragments associated with the primitive that fail a z-test are culled, and transmitted to a clipping engine where fragments lying outside a viewing frustum are clipped. Those fragments that survive clipping and culling may be passed to the fine raster engine to generate attributes for the pixel fragments based on the plane equations generated by the setup engine. The output of the raster engine 1206 comprises fragments to be processed, for example, by a fragment shader implemented within a data processing cluster 1212.

Each data processing cluster 1212 included in the general processing cluster 1200 includes an M-pipe controller 1216, a primitive engine 1214, and one or more streaming multiprocessor 1400 modules. The M-pipe controller 1216 controls the operation of the data processing cluster 1212, routing packets received from the pipeline manager 1202 to the appropriate units in the data processing cluster 1212. For example, packets associated with a vertex may be routed to the primitive engine 1214, which is configured to fetch vertex attributes associated with the vertex from the memory 1120. In contrast, packets associated with a shader program may be transmitted to the streaming multiprocessor 1400.

The streaming multiprocessor 1400 comprises a programmable streaming processor that is configured to process tasks represented by a number of threads. Each streaming multiprocessor 1400 is multi-threaded and configured to execute a plurality of threads (e.g., 32 threads) from a particular group of threads concurrently. In an embodiment, the streaming multiprocessor 1400 implements a Single-Instruction, Multiple-Data (SIMD) architecture where each thread in a group of threads (e.g., a warp) is configured to process a different set of data based on the same set of instructions. All threads in the group of threads execute the same instructions. In another embodiment, the streaming multiprocessor 1400 implements a Single-Instruction, Multiple Thread (SIMT) architecture where each thread in a group of threads is configured to process a different set of data based on the same set of instructions, but where individual threads in the group of threads are allowed to diverge during execution. In an embodiment, a program counter, call stack, and execution state is maintained for each warp, enabling concurrency between warps and serial execution within warps when threads within the warp diverge. In another embodiment, a program counter, call stack, and execution state is maintained for each individual thread, enabling equal concurrency between all threads, within and between warps. When execution state is maintained for each individual thread, threads executing the same instructions may be converged and executed in parallel for maximum efficiency. The streaming multiprocessor 1400 will be described in more detail below in conjunction with FIG. 14.

The memory management unit 1210 provides an interface between the general processing cluster 1200 and the memory partition unit 1300. The memory management unit 1210 may provide translation of virtual addresses into physical addresses, memory protection, and arbitration of memory requests. In an embodiment, the memory management unit 1210 provides one or more translation lookaside buffers (TLBs) for performing translation of virtual addresses into physical addresses in the memory 1120.

FIG. 13 depicts a memory partition unit 1300 of the parallel processing unit 1102 of FIG. 11, in accordance with an embodiment. As shown in FIG. 13, the memory partition unit 1300 includes a raster operations unit 1302, a level two cache 1304, and a memory interface 1306. The memory interface 1306 is coupled to the memory 1120. Memory interface 1306 may implement 32, 64, 128, 1024-bit data buses, or the like, for high-speed data transfer. In an embodiment, the parallel processing unit 1102 incorporates U memory interface 1306 modules, one memory interface 1306 per pair of memory partition unit 1300 modules, where each pair of memory partition unit 1300 modules is connected to a corresponding memory 1120 device. For example, parallel processing unit 1102 may be connected to up to Y memory 1120 devices, such as high bandwidth memory stacks or graphics double-data-rate, version 5, synchronous dynamic random access memory, or other types of persistent storage.

In an embodiment, the memory interface 1306 implements an HBM2 memory interface and Y equals half U. In an embodiment, the HBM2 memory stacks are located on the same physical package as the parallel processing unit 1102, providing substantial power and area savings compared with conventional GDDR5 SDRAM systems. In an embodiment, each HBM2 stack includes four memory dies and Y equals 4, with HBM2 stack including two 128-bit channels per die for a total of 8 channels and a data bus width of 1024 bits.

In an embodiment, the memory 1120 supports Single-Error Correcting Double-Error Detecting (SECDED) Error Correction Code (ECC) to protect data. ECC provides higher reliability for compute applications that are sensitive to data corruption. Reliability is especially important in large-scale cluster computing environments where parallel processing unit 1102 modules process very large datasets and/or run applications for extended periods.

In an embodiment, the parallel processing unit 1102 implements a multi-level memory hierarchy. In an embodiment, the memory partition unit 1300 supports a unified memory to provide a single unified virtual address space for CPU and parallel processing unit 1102 memory, enabling data sharing between virtual memory systems. In an embodiment the frequency of accesses by a parallel processing unit 1102 to memory located on other processors is traced to ensure that memory pages are moved to the physical memory of the parallel processing unit 1102 that is accessing the pages more frequently. In an embodiment, the NVLink 1116 supports address translation services allowing the parallel processing unit 1102 to directly access a CPU's page tables and providing full access to CPU memory by the parallel processing unit 1102.

In an embodiment, copy engines transfer data between multiple parallel processing unit 1102 modules or between parallel processing unit 1102 modules and CPUs. The copy engines can generate page faults for addresses that are not mapped into the page tables. The memory partition unit 1300 can then service the page faults, mapping the addresses into the page table, after which the copy engine can perform the transfer. In a conventional system, memory is pinned (e.g., non-pageable) for multiple copy engine operations between multiple processors, substantially reducing the available memory. With hardware page faulting, addresses can be passed to the copy engines without worrying if the memory pages are resident, and the copy process is transparent.

Data from the memory 1120 or other system memory may be fetched by the memory partition unit 1300 and stored in the level two cache 1304, which is located on-chip and is shared between the various general processing cluster 1200 modules. As shown, each memory partition unit 1300 includes a portion of the level two cache 1304 associated with a corresponding memory 1120 device. Lower level caches may then be implemented in various units within the general processing cluster 1200 modules. For example, each of the streaming multiprocessor 1400 modules may implement an L1 cache. The L1 cache is private memory that is dedicated to a particular streaming multiprocessor 1400. Data from the level two cache 1304 may be fetched and stored in each of the L1 caches for processing in the functional units of the streaming multiprocessor 1400 modules. The level two cache 1304 is coupled to the memory interface 1306 and the crossbar 1114.

The raster operations unit 1302 performs graphics raster operations related to pixel color, such as color compression, pixel blending, and the like. The raster operations unit 1302 also implements depth testing in conjunction with the raster engine 1206, receiving a depth for a sample location associated with a pixel fragment from the culling engine of the raster engine 1206. The depth is tested against a corresponding depth in a depth buffer for a sample location associated with the fragment. If the fragment passes the depth test for the sample location, then the raster operations unit 1302 updates the depth buffer and transmits a result of the depth test to the raster engine 1206. It will be appreciated that the number of partition memory partition unit 1300 modules may be different than the number of general processing cluster 1200 modules and, therefore, each raster operations unit 1302 may be coupled to each of the general processing cluster 1200 modules. The raster operations unit 1302 tracks packets received from the different general processing cluster 1200 modules and determines which general processing cluster 1200 that a result generated by the raster operations unit 1302 is routed to through the crossbar 1114. Although the raster operations unit 1302 is included within the memory partition unit 1300 in FIG. 13, in other embodiment, the raster operations unit 1302 may be outside of the memory partition unit 1300. For example, the raster operations unit 1302 may reside in the general processing cluster 1200 or another unit.

FIG. 14 illustrates the streaming multiprocessor 1400 of FIG. 12, in accordance with an embodiment. As shown in FIG. 14, the streaming multiprocessor 1400 includes an instruction cache 1402, one or more scheduler unit 1404 modules (e.g., such as scheduler unit 1108), a register file 1406, one or more processing core 1408 modules, one or more special function unit 1410 modules, one or more load/store unit 1412 modules, an interconnect network 1414, and a shared memory/L1 cache 1416.

As described above, the work distribution unit 1110 dispatches tasks for execution on the general processing cluster 1200 modules of the parallel processing unit 1102. The tasks are allocated to a particular data processing cluster 1212 within a general processing cluster 1200 and, if the task is associated with a shader program, the task may be allocated to a streaming multiprocessor 1400. The scheduler unit 1108 receives the tasks from the work distribution unit 1110 and manages instruction scheduling for one or more thread blocks assigned to the streaming multiprocessor 1400. The scheduler unit 1404 schedules thread blocks for execution as warps of parallel threads, where each thread block is allocated at least one warp. In an embodiment, each warp executes 32 threads. The scheduler unit 1404 may manage a plurality of different thread blocks, allocating the warps to the different thread blocks and then dispatching instructions from the plurality of different cooperative groups to the various functional units (e.g., core 1408 modules, special function unit 1410 modules, and load/store unit 1412 modules) during each clock cycle.

Cooperative Groups is a programming model for organizing groups of communicating threads that allows developers to express the granularity at which threads are communicating, enabling the expression of richer, more efficient parallel decompositions. Cooperative launch APIs support synchronization amongst thread blocks for the execution of parallel algorithms. Conventional programming models provide a single, simple construct for synchronizing cooperating threads: a barrier across all threads of a thread block (e.g., the syncthreads( ) function). However, programmers would often like to define groups of threads at smaller than thread block granularities and synchronize within the defined groups to enable greater performance, design flexibility, and software reuse in the form of collective group-wide function interfaces.

Cooperative Groups enables programmers to define groups of threads explicitly at sub-block (e.g., as small as a single thread) and multi-block granularities, and to perform collective operations such as synchronization on the threads in a cooperative group. The programming model supports clean composition across software boundaries, so that libraries and utility functions can synchronize safely within their local context without having to make assumptions about convergence. Cooperative Groups primitives enable new patterns of cooperative parallelism, including producer-consumer parallelism, opportunistic parallelism, and global synchronization across an entire grid of thread blocks.

A dispatch 1418 unit is configured within the scheduler unit 1404 to transmit instructions to one or more of the functional units. In one embodiment, the scheduler unit 1404 includes two dispatch 1418 units that enable two different instructions from the same warp to be dispatched during each clock cycle. In alternative embodiments, each scheduler unit 1404 may include a single dispatch 1418 unit or additional dispatch 1418 units.

Each streaming multiprocessor 1400 includes a register file 1406 that provides a set of registers for the functional units of the streaming multiprocessor 1400. In an embodiment, the register file 1406 is divided between each of the functional units such that each functional unit is allocated a dedicated portion of the register file 1406. In another embodiment, the register file 1406 is divided between the different warps being executed by the streaming multiprocessor 1400. The register file 1406 provides temporary storage for operands connected to the data paths of the functional units.

Each streaming multiprocessor 1400 comprises L processing core 1408 modules. In an embodiment, the streaming multiprocessor 1400 includes a large number (e.g., 128, etc.) of distinct processing core 1408 modules. Each core 1408 may include a fully-pipelined, single-precision, double-precision, and/or mixed precision processing unit that includes a floating point arithmetic logic unit and an integer arithmetic logic unit. In an embodiment, the floating point arithmetic logic units implement the IEEE 754-2008 standard for floating point arithmetic. In an embodiment, the core 1408 modules include 64 single-precision (32-bit) floating point cores, 64 integer cores, 32 double-precision (64-bit) floating point cores, and 8 tensor cores.

Tensor cores configured to perform matrix operations, and, in an embodiment, one or more tensor cores are included in the core 1408 modules. In particular, the tensor cores are configured to perform deep learning matrix arithmetic, such as convolution operations for neural network training and inferencing. In an embodiment, each tensor core operates on a 4×4 matrix and performs a matrix multiply and accumulate operation D=A′B+C, where A, B, C, and D are 4×4 matrices.

In an embodiment, the matrix multiply inputs A and B are 16-bit floating point matrices, while the accumulation matrices C and D may be 16-bit floating point or 32-bit floating point matrices. Tensor Cores operate on 16-bit floating point input data with 32-bit floating point accumulation. The 16-bit floating point multiply requires 64 operations and results in a full precision product that is then accumulated using 32-bit floating point addition with the other intermediate products for a 4×4×4 matrix multiply. In practice, Tensor Cores are used to perform much larger two-dimensional or higher dimensional matrix operations, built up from these smaller elements. An API, such as CUDA 9 C++ API, exposes specialized matrix load, matrix multiply and accumulate, and matrix store operations to efficiently use Tensor Cores from a CUDA-C++ program. At the CUDA level, the warp-level interface assumes 16×16 size matrices spanning all 32 threads of the warp.

Each streaming multiprocessor 1400 also comprises M special function unit 1410 modules that perform special functions (e.g., attribute evaluation, reciprocal square root, and the like). In an embodiment, the special function unit 1410 modules may include a tree traversal unit configured to traverse a hierarchical tree data structure. In an embodiment, the special function unit 1410 modules may include texture unit configured to perform texture map filtering operations. In an embodiment, the texture units are configured to load texture maps (e.g., a 2D array of texels) from the memory 1120 and sample the texture maps to produce sampled texture values for use in shader programs executed by the streaming multiprocessor 1400. In an embodiment, the texture maps are stored in the shared memory/L1 cache 1416. The texture units implement texture operations such as filtering operations using mip-maps (e.g., texture maps of varying levels of detail). In an embodiment, each streaming multiprocessor 1400 includes two texture units.

Each streaming multiprocessor 1400 also comprises N load/store unit 1412 modules that implement load and store operations between the shared memory/L1 cache 1416 and the register file 1406. Each streaming multiprocessor 1400 includes an interconnect network 1414 that connects each of the functional units to the register file 1406 and the load/store unit 1412 to the register file 1406 and shared memory/L1 cache 1416. In an embodiment, the interconnect network 1414 is a crossbar that can be configured to connect any of the functional units to any of the registers in the register file 1406 and connect the load/store unit 1412 modules to the register file 1406 and memory locations in shared memory/L1 cache 1416.

The shared memory/L1 cache 1416 is an array of on-chip memory that allows for data storage and communication between the streaming multiprocessor 1400 and the primitive engine 1214 and between threads in the streaming multiprocessor 1400. In an embodiment, the shared memory/L1 cache 1416 comprises 128 KB of storage capacity and is in the path from the streaming multiprocessor 1400 to the memory partition unit 1300. The shared memory/L1 cache 1416 can be used to cache reads and writes. One or more of the shared memory/L1 cache 1416, level two cache 1304, and memory 1120 are backing stores.

Combining data cache and shared memory functionality into a single memory block provides the best overall performance for both types of memory accesses. The capacity is usable as a cache by programs that do not use shared memory. For example, if shared memory is configured to use half of the capacity, texture and load/store operations can use the remaining capacity. Integration within the shared memory/L1 cache 1416 enables the shared memory/L1 cache 1416 to function as a high-throughput conduit for streaming data while simultaneously providing high-bandwidth and low-latency access to frequently reused data.

When configured for general purpose parallel computation, a simpler configuration can be used compared with graphics processing. Specifically, the fixed function graphics processing units shown in FIG. 11, are bypassed, creating a much simpler programming model. In the general purpose parallel computation configuration, the work distribution unit 1110 assigns and distributes blocks of threads directly to the data processing cluster 1212 modules. The threads in a block execute the same program, using a unique thread ID in the calculation to ensure each thread generates unique results, using the streaming multiprocessor 1400 to execute the program and perform calculations, shared memory/L1 cache 1416 to communicate between threads, and the load/store unit 1412 to read and write global memory through the shared memory/L1 cache 1416 and the memory partition unit 1300. When configured for general purpose parallel computation, the streaming multiprocessor 1400 can also write commands that the scheduler unit 1108 can use to launch new work on the data processing cluster 1212 modules.

The parallel processing unit 1102 may be included in a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, and the like. In an embodiment, the parallel processing unit 1102 is embodied on a single semiconductor substrate. In another embodiment, the parallel processing unit 1102 is included in a system-on-a-chip (SoC) along with one or more other devices such as additional parallel processing unit 1102 modules, the memory 1120, a reduced instruction set computer (RISC) CPU, a memory management unit (MMU), a digital-to-analog converter (DAC), and the like.

In an embodiment, the parallel processing unit 1102 may be included on a graphics card that includes one or more memory devices. The graphics card may be configured to interface with a PCIe slot on a motherboard of a desktop computer. In yet another embodiment, the parallel processing unit 1102 may be an integrated graphics processing unit (iGPU) or parallel processor included in the chipset of the motherboard.

### Exemplary Computing System

Systems with multiple GPUs and CPUs are used in a variety of industries as developers expose and leverage more parallelism in applications such as artificial intelligence computing. High-performance GPU-accelerated systems with tens to many thousands of compute nodes are deployed in data centers, research facilities, and supercomputers to solve ever larger problems. As the number of processing devices within the high-performance systems increases, the communication and data transfer mechanisms need to scale to support the increased bandwidth.

FIG. 15 is a conceptual diagram of a processing system 1500 implemented using the parallel processing unit 1102 of FIG. 11, in accordance with an embodiment. The processing system 1500 includes a central processing unit 1504, switch 1506, and multiple parallel processing unit 1102 modules each and respective memory 1120 modules. The NVLink 1116 provides high-speed communication links between each of the parallel processing unit 1102 modules. Although a particular number of NVLink 1116 and interconnect 1118 connections are illustrated in FIG. 15, the number of connections to each parallel processing unit 1102 and the central processing unit 1504 may vary. The switch 1506 interfaces between the interconnect 1118 and the central processing unit 1504. The parallel processing unit 1102 modules, memory 1120 modules, and NVLink 1116 connections may be situated on a single semiconductor platform to form a parallel processing module 1502. In an embodiment, the switch 1506 supports two or more protocols to interface between various different connections and/or links.

In another embodiment (not shown), the NVLink 1116 provides one or more high-speed communication links between each of the parallel processing unit modules (parallel processing unit 1102, parallel processing unit 1102, parallel processing unit 1102, and parallel processing unit 1102) and the central processing unit 1504 and the switch 1506 interfaces between the interconnect 1118 and each of the parallel processing unit modules. The parallel processing unit modules, memory 1120 modules, and interconnect 1118 may be situated on a single semiconductor platform to form a parallel processing module 1502. In yet another embodiment (not shown), the interconnect 1118 provides one or more communication links between each of the parallel processing unit modules and the central processing unit 1504 and the switch 1506 interfaces between each of the parallel processing unit modules using the NVLink 1116 to provide one or more high-speed communication links between the parallel processing unit modules. In another embodiment (not shown), the NVLink 1116 provides one or more high-speed communication links between the parallel processing unit modules and the central processing unit 1504 through the switch 1506. In yet another embodiment (not shown), the interconnect 1118 provides one or more communication links between each of the parallel processing unit modules directly. One or more of the NVLink 1116 high-speed communication links may be implemented as a physical NVLink interconnect or either an on-chip or on-die interconnect using the same protocol as the NVLink 1116.

In the context of the present description, a single semiconductor platform may refer to a sole unitary semiconductor-based integrated circuit fabricated on a die or chip. It should be noted that the term single semiconductor platform may also refer to multi-chip modules with increased connectivity which simulate on-chip operation and make substantial improvements over utilizing a conventional bus implementation. Of course, the various circuits or devices may also be situated separately or in various combinations of semiconductor platforms per the desires of the user. Alternately, the parallel processing module 1502 may be implemented as a circuit board substrate and each of the parallel processing unit modules and/or memory 1120 modules may be packaged devices. In an embodiment, the central processing unit 1504, switch 1506, and the parallel processing module 1502 are situated on a single semiconductor platform.

In an embodiment, the signaling rate of each NVLink 1116 is 20 to 25 Gigabits/second and each parallel processing unit module includes six NVLink 1116 interfaces (as shown in FIG. 15, five NVLink 1116 interfaces are included for each parallel processing unit module). Each NVLink 1116 provides a data transfer rate of 25 Gigabytes/second in each direction, with six links providing 300 Gigabytes/second. The NVLink 1116 can be used exclusively for PPU-to-PPU communication as shown in FIG. 15, or some combination of PPU-to-PPU and PPU-to-CPU, when the central processing unit 1504 also includes one or more NVLink 1116 interfaces.

In an embodiment, the NVLink 1116 allows direct load/store/atomic access from the central processing unit 1504 to each parallel processing unit module's memory 1120. In an embodiment, the NVLink 1116 supports coherency operations, allowing data read from the memory 1120 modules to be stored in the cache hierarchy of the central processing unit 1504, reducing cache access latency for the central processing unit 1504. In an embodiment, the NVLink 1116 includes support for Address Translation Services (ATS), enabling the parallel processing unit module to directly access page tables within the central processing unit 1504. One or more of the NVLink 1116 may also be configured to operate in a low-power mode.

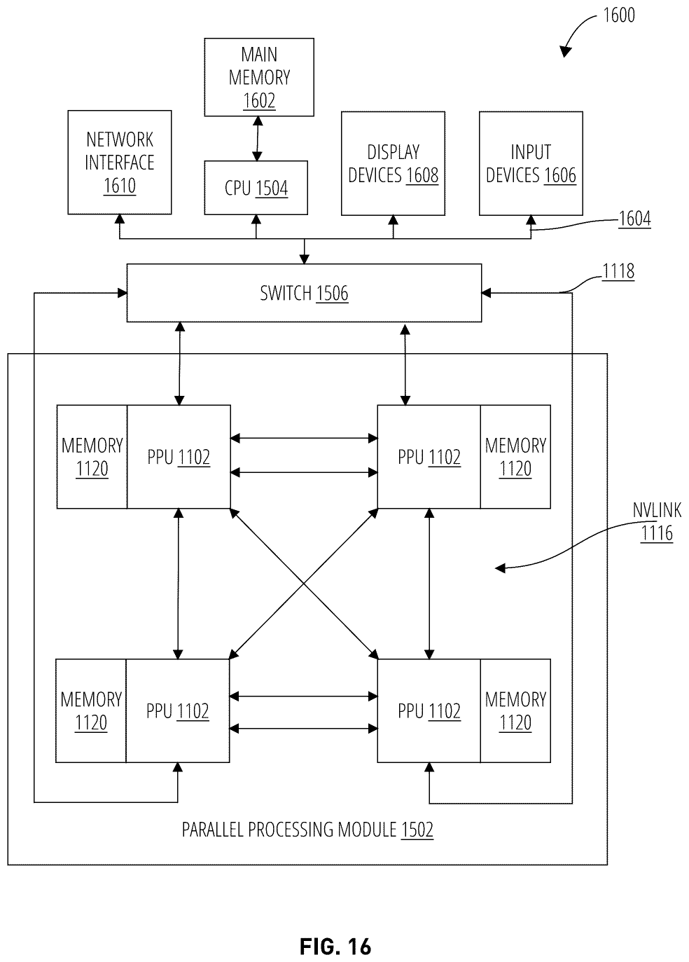

FIG. 16 depicts an exemplary processing system 1600 in which the various architecture and/or functionality of the various previous embodiments may be implemented. As shown, an exemplary processing system 1600 is provided including at least one central processing unit 1504 that is connected to a communications bus 1604. The communication communications bus 1604 may be implemented using any suitable protocol, such as PCI (Peripheral Component Interconnect), PCI-Express, AGP (Accelerated Graphics Port), HyperTransport, or any other bus or point-to-point communication protocol(s). The exemplary processing system 1600 also includes a main memory 1602. Control logic (software) and data are stored in the main memory 1602 which may take the form of random access memory (RAM).

The exemplary processing system 1600 also includes input devices 1606, the parallel processing module 1502, and display devices 1608, e.g. a conventional CRT (cathode ray tube), LCD (liquid crystal display), LED (light emitting diode), plasma display or the like. User input may be received from the input devices 1606, e.g., keyboard, mouse, touchpad, microphone, and the like. Each of the foregoing modules and/or devices may even be situated on a single semiconductor platform to form the exemplary processing system 1600. Alternately, the various modules may also be situated separately or in various combinations of semiconductor platforms per the desires of the user.

Further, the exemplary processing system 1600 may be coupled to a network (e.g., a telecommunications network, local area network (LAN), wireless network, wide area network (WAN) such as the Internet, peer-to-peer network, cable network, or the like) through a network interface 1610 for communication purposes.

The exemplary processing system 1600 may also include a secondary storage (not shown). The secondary storage includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner.

Computer programs, or computer control logic algorithms, may be stored in the main memory 1602 and/or the secondary storage. Such computer programs, when executed, enable the exemplary processing system 1600 to perform various functions. The main memory 1602, the storage, and/or any other storage are possible examples of computer-readable media.

The architecture and/or functionality of the various previous figures may be implemented in the context of a general computer system, a circuit board system, a game console system dedicated for entertainment purposes, an application-specific system, and/or any other desired system. For example, the exemplary processing system 1600 may take the form of a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, a mobile phone device, a television, workstation, game consoles, embedded system, and/or any other type of logic.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

### LISTING OF DRAWING ELEMENTS

502 control settings
504 identity
506 expression
508 pose
510 generator
512 Gaussian avatar
514 rasterizer
516 animation
602 global discriminator
604 local discriminator
702 expressive deformation model
704 residual Gaussian attributes
706 discriminator
708 detail
710 animated mesh
712 base Gaussian attributes
714 generator model
716 generator model
718 total Gaussian attributes
720 animated Gaussians
722 template mesh
802 base model
804 trainable residual model
1102 parallel processing unit
1104 I/O unit
1106 front-end unit
1108 scheduler unit
1110 work distribution unit
1112 hub
1114 crossbar
1116 NVLink
1118 interconnect
1120 memory
1200 general processing cluster
1202 pipeline manager
1204 pre-raster operations unit
1206 raster engine
1208 work distribution crossbar
1210 memory management unit
1212 data processing cluster
1214 primitive engine
1216 M-pipe controller
1300 memory partition unit
1302 raster operations unit
1304 level two cache
1306 memory interface
1400 streaming multiprocessor
1402 instruction cache
1404 scheduler unit
1406 register file
1408 core
1410 special function unit
1412 load/store unit
1414 interconnect network
1416 shared memory/L1 cache
1418 dispatch
1500 processing system
1502 parallel processing module
1504 central processing unit
1506 switch
1600 exemplary processing system
1602 main memory
1604 communications bus
1606 input devices
1608 display devices
1610 network interface

Various functional operations described herein may be implemented in logic that is referred to using a noun or noun phrase reflecting said operation or function. For example, an association operation may be carried out by an “associator” or “correlator”. Likewise, switching may be carried out by a “switch”, selection by a “selector”, and so on. “Logic” refers to machine memory circuits and non-transitory machine readable media comprising machine-executable instructions (software and firmware), and/or circuitry (hardware) which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter). Logic symbols in the drawings should be understood to have their ordinary interpretation in the art in terms of functionality and various structures that may be utilized for their implementation, unless otherwise indicated.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “credit distribution circuit configured to distribute credits to a plurality of processor cores” is intended to cover, for example, an integrated circuit that has circuitry that performs this function during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed FPGA, for example, would not be considered to be “configured to” perform some specific function, although it may be “configurable to” perform that function after programming.

Reciting in the appended claims that a structure is “configured to” perform one or more tasks is expressly intended not to invoke 35 U.S.C. § 112(f) for that claim element. Accordingly, claims in this application that do not otherwise include the “means for” [performing a function] construct should not be interpreted under 35 U.S.C § 112(f).

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede, and do not imply any type of ordering (e.g., spatial, temporal, logical, etc.), unless stated otherwise. For example, in a register file having eight registers, the terms “first register” and “second register” can be used to refer to any two of the eight registers, and not, for example, just logical registers 0 and 1.

When used in the claims, the term “or” is used as an inclusive or and not as an exclusive or. For example, the phrase “at least one of x, y, or z” means any one of x, y, and z, as well as any combination thereof.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

Although the terms “step” and/or “block” may be used herein to connote different elements of methods employed, the terms should not be interpreted as implying any particular order among or between various steps herein disclosed unless and except when the order of individual steps is explicitly described.

Having thus described illustrative embodiments in detail, it will be apparent that modifications and variations are possible without departing from the scope of the intended invention as claimed. The scope of inventive subject matter is not limited to the depicted embodiments but is rather set forth in the following Claims.

What is claimed is:

1. An animation system comprising:
an expressive deformation model configured to transform expression settings, pose settings, and a template mesh into an animatable mesh;
a first generator branch configured to transform identity controls for the animatable mesh into base Gaussian attributes;
a second generator branch configured to transform detail controls for the animatable mesh into residual Gaussian attributes; and
the system configured to embed the base Gaussian attributes and residual Gaussian attributes in UV maps of the animatable mesh and to combine the UV maps and the animatable mesh to form an animatable Gaussian representation of an object to animate.

2. The animation system of claim 1, further comprising a rasterizer configured to apply Gaussian splatting to the animatable Gaussian representation to generate an animation.

3. The animation system of claim 2, further comprising:
a global discriminator configured to operate on the animation; and
at least one local discriminator configured to operate on the animation.

4. The animation system of claim 3, wherein the expressive deformation model, first generator branch, second generator branch, global discriminator, and at least one local discriminator are configured as a Generative Adversarial Network.

5. The animation system of claim 1, wherein the animation is an avatar of a human head.

6. The animation system of claim 1, wherein the pose settings comprise settings for jaw, neck, and eyeball configuration.

7. The animation system of claim 1, wherein the expressive deformation model comprises a base model and a residual model.

8. The animation system of claim 7, configured to fix parameters of the base model and train parameters of the residual model.

9. The animation system of claim 1, configured to embed Gaussian positions on the animatable mesh surface with barycentric weights and normal displacements.

10. The animation system of claim 1, configured to embed Gaussian attributes for one or more of rotation, scale, opacity and appearance in the UV maps.

11. An animation process comprising:
transforming expression settings, pose settings, and a template mesh into an animatable mesh with a deformation model;
transforming identity controls for the animatable mesh into base Gaussian attributes;
transforming detail controls for the animatable mesh into residual Gaussian attributes;
embedding the base Gaussian attributes and residual Gaussian attributes in UV maps of the animatable mesh; and
combining the UV maps and the animatable mesh to form an animatable Gaussian representation of an object to animate.

12. The animation process of claim 11, further comprising:
applying Gaussian splatting to the animatable Gaussian representation to generate an animation.

13. The animation process of claim 12, further comprising:
operating on the animation with a global discriminator; and
operating on the animation with at least one local discriminator.

14. The animation process of claim 13, wherein transforming the expression settings, the pose settings, and the template mesh into an animatable mesh, transforming the identity controls for the animatable mesh into the base Gaussian attributes, and transforming the detail controls for the animatable mesh into residual Gaussian attributes are carried out by a Generative Adversarial Network.

15. The animation process of claim 11, wherein the animation is an avatar of a human head.

16. The animation process of claim 11, wherein the pose settings comprise settings for jaw, neck, and eyeball configuration.

17. The animation process of claim 11, wherein the deformation model comprises a base model and a residual model.

18. The animation process of claim 17, further comprising:
fixing parameters of the base model; and
training parameters of the residual model.

19. The animation process of claim 11, further comprising:
embedding Gaussian positions on the animatable mesh surface with barycentric weights and normal displacements.

20. The animation process of claim 11, further comprising:
embedding Gaussian attributes for one or more of rotation, scale, opacity and appearance in the UV maps.

21. A non-volatile media comprising machine-readable instructions that, when applied to one or more data processors of a computer system, configure the computer system to:
transform expression settings, pose settings, and a template mesh into an animatable mesh with a deformation model;
transform identity controls for the animatable mesh into base Gaussian attributes;
transform detail controls for the animatable mesh into residual Gaussian attributes;
embed the base Gaussian attributes and residual Gaussian attributes in UV maps of the animatable mesh; and
combine the UV maps and the animatable mesh to form an animatable Gaussian representation of an object to animate.
